(19) United States
(12) Patent Application Publication
(10) Pub. No.: US 2019/0268159 A1
(43) Pub. Date: Aug. 29, 2019

(54) SYSTEM AND METHOD FOR A DIGITAL IDENTITY SYSTEM

(71) Applicant: Walmart Apollo, LLC, Bentonville, AR (US)

(72) Inventors: Donald R. HIGH, Noel, MO (US); Bruce WILKINSON, Rogers, AR (US); John J. O'BRIEN, Farmington, AR (US); Robert CANTRELL, Herndon, VA (US); Brian MCHALE, Oldham (GB); Joseph JURICH, Molino, FL (US); Jennifer HEDGES, Lowell, AR (US)

(73) Assignee: Walmart Apollo, LLC, Bentonville, AR (US)

(21) Appl. No.: 16/288,360

(22) Filed: Feb. 28, 2019

Related U.S. Application Data
(60) Provisional application No. 62/636,740, filed on Feb. 28, 2018.

(51) Int. Cl. H04L 9/32; H04L 29/06; H04L 9/06; G06Q 20/40

(52) U.S. Cl. CPC H04L 9/3231; H04L 9/3239; G06Q 20/40145; H04L 9/0637; H04L 63/105

(57) ABSTRACT

Systems, methods, and computer-readable storage media for using multilayered authentication mechanisms, combined with hashing functions, to provide increased security and accuracy in identification of a user. One example is using facial biometric data as input to a hash function, and comparing that hash function output to previously stored hash function outputs to determine if the facial data captured matches that of a known user. Then, once a facial match is determined using the hashed values, a secondary confirmation is requested and/or received. If that secondary confirmation also matches stored data, the user is authorized to perform the transaction or access the restricted area.

### PRIORITY

The present application claims priority to U.S. Provisional Patent Application No. 62/636,740, filed Feb. 28, 2018, the contents of which are incorporated herein in their entirety.

### BACKGROUND

### 1. Technical Field

The present disclosure relates to identification systems, and more specifically to an identification system using multiple authentication sources to verify a user's identity.

### 2. Introduction

Authenticating someone's identity often relies on driver's licenses, passports, and other government issued identification documents. However, forgery of such documents is a constant problem. To counter forgeries, government entities often employ watermarks, holograms, and other technologies. Despite these counter-measures, forgeries still occur. In addition, as technology continues to evolve, the desire of carry wallets, purses, and other objects to hold such identifications is diminishing. With a user's permission, biometric information may be used to verify identity.

### SUMMARY

An exemplary method which can be performed according to the concepts disclosed herein can include: receiving, at a facial biometric scanner, optical data associated with a face of a user; converting, via a processor, the optical data into facial biometric data, the facial biometric data identifying relational aspects of features of the face contained within the optical data; performing, via the processor, a hash function on the optical data, to yield hashed facial biometric data; verifying, via the processor, the hashed facial biometric data as matching previously hashed biometric data stored in a private ledger, to yield a comparison; identifying, based on the comparison, the optical data as associated with a verified user; after identifying the optical data as associated with the verified user, receiving an additional confirmation from the user; comparing the additional confirmation to stored confirmation data stored in the private ledger, to yield a second comparison; and verifying the user as an authorized user.

An exemplary system configured according to this disclosure can include: a facial biometric scanner; a processor; and a computer-readable storage medium having instructions stored which, when executed by the processor, cause the processor to perform operations comprising: receiving, at the facial biometric scanner, optical data associated with a face of a user; converting the optical data into facial biometric data, the facial biometric data identifying relational aspects of features of the face contained within the optical data; performing a hash function on the optical data, to yield hashed facial biometric data; verifying the hashed facial biometric data as matching previously hashed biometric data stored in a blockchain ledger, to yield a comparison; identifying, based on the comparison, the optical data as associated with a verified user; after identifying the optical data as associated with the verified user, receiving an additional confirmation from the user; comparing the additional confirmation to stored confirmation data stored in the blockchain ledger, to yield a second comparison; and verifying the user as an authorized user.

An exemplary non-transitory computer-readable storage medium configured according to this disclosure can have instructions stored which, when executed by a computing device, cause the computing device to perform operations which can include: receiving, at a facial biometric scanner, optical data associated with a face of a user; converting the optical data into facial biometric data, the facial biometric data identifying relational aspects of features of the face contained within the optical data; performing a hash function on the optical data, to yield hashed facial biometric data; verifying the hashed facial biometric data as matching previously hashed biometric data stored in a blockchain ledger, to yield a comparison; identifying, based on the comparison, the optical data as associated with a verified user; after identifying the optical data as associated with the verified user, receiving an additional confirmation from the user; comparing the additional confirmation to stored confirmation data stored in the blockchain ledger, to yield a second comparison; and verifying the user as an authorized user.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary authentication of a user;

FIG. 2 illustrates a variable challenge level based on specific inputs;

FIG. 3 illustrates an exemplary method embodiment;

FIG. 4 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Systems configured according to this disclosure can use a combination of facial recognition, voice recognition, fob RF (Radio Frequency), question, captcha, and/or other biometric data to confirm the identity of a user. As data is received, it is used as an input to a hash function, the output of which is then compared to previously stored hashed outputs associated with known users. When a match is found, this can indicate that the input provided matches that of a known user. After a first confirmation that the initial data received is associated with a known user, a second confirmation can be requested. The system can vary the type of confirmation required based on the access being requested, the behavioral patterns of the user, the time of day, etc. As the user provides the second confirmation, the second confirmation is again compared to stored data (the second confirmation may or may not be hashed and compared to other stored hashed outputs, depending on the configuration). When the second confirmation matches stored information, the system can then identify the user as an authorized user and provide them the access requested.

The systems and methods disclosed herein can be configured to comply with privacy requirements which may vary between jurisdictions. For example, before any recording or capturing of user biometric data, a “consent to capture” process may be implemented. In such a process, consent may be obtained, from the user, via a registration for a service. Part of the registration process may be to ensure compliance with the appropriate privacy laws for the location where the service would be performed. No unauthorized collection of biometric data of individuals occurs via exemplary systems and methods.

After registration, as part of a two factor authentication system and before performance of the service, a verification of the user as registered with the system and providing the required consents can occur. That is, the user's registration status as having consented to the collection of biometric data can be verified prior to collecting any biometric data. This verification can take place, for example, by the user entering a PIN (Personal Identification Number), password, or other code into a keypad or keyboard; by the user entering into a limited geofence location while carrying a fob, mobile device (such as a smartphone), or other RF transmitter, where the device has been configured to broadcast an authorization signal. In other configurations, and where permitted the collection of biometric data can be affirmatively allowed by the user, such as where the user initiates a fingerprint scan, a palm scan, iris scan, etc., by orienting their body or hand in a particular way.

Once consent is verified, biometric data of the user can be captured and used, for example, as part of a two factor authentication system. If the user verification fails at any point during the two factor authentication, the camera, sensor, or other biometric data collection system is immediately turned off, and any biometric data collected from the user is immediately deleted, not having been saved to disk.

Preferably, any biometric data captured as part of the verification process is handled and stored by a single party at a single location. Where data must be transmitted to an offsite location for verification, the biometric data is encrypted. As will be discussed further below, the hashing of the biometric data received is a form of asymmetrical encryption which improves both data security and privacy, as well as reducing the amount of data which needs to be communicated.

Consider the following example. A deliveryman arrives by himself at a distribution center. As the deliveryman approaches the access gate, the deliveryman's face is scanned by a facial recognition scanner. The facial recognition scanner receives the reflected light of the deliveryman's face, then converts that optical data into a digital representation of the deliveryman's face. The digital representation (or an Identification (ID) of an identified face) is used as an input to a hash function. The hash function generates an output of a fixed size, which is then compared to previous hash function outputs of authorized workers at the distribution center. If the hash function output matches that of a previously saved hash function output, (1) the identity of the deliveryman can be inferred using data associated with the previously saved hash function output, and (2) a subsequent stage of the user identification process can begin.

Continuing with the example of the deliveryman, when his face is recognized the system can determine the level of importance and/or difficulty of subsequent confirmation required to access the distribution facility. In a first example, the deliveryman must then present a fob (such as a key fob) with an RFID (Radio Frequency Identification) associated with the identity inferred from the hashed output of the facial recognition analysis. In another example, the deliveryman must present a voiceprint by stating a pre-set word, phrase, password, or sentence. In yet another example, the deliveryman may be required to present additional biometric data, such as a fingerprint, a handprint, a retinal scan, etc. Which additional confirmation is required can vary according to configuration, or according to the history of the deliveryman with this distribution center, planned deliveries, time of day, goods being delivered, and/or security requirements of the distribution center. For example, if the deliveryman delivers goods every day at noon, a key fob/RFID may normally be required. However, if the deliveryman appears at an unexpected time, a voiceprint may be required. Likewise, if the deliveryman is delivering a distinct type of cargo, the second verification required may change from a commonly used verification to a second, more difficult to forge confirmation element.

The second confirmation data received may, in some configurations, be used as input to a hash function. The output of that hash function may, like the facial recognition data, be compared to stored data to further confirm the identity of the deliveryman. Once the hashed facial recognition output and the second, subsequent confirmation data are both compared to stored data, the identity of the deliveryman is verified as accurate and the deliveryman is granted access to the distribution center.

In another example of a deliveryman, local regulations may prohibit indiscriminate collection of biometric data, such as facial biometric data. In such instances, the present invention can be configured such that the first confirmation data the system receives is from an RFID located in a key fob, mobile device, or security badge, and which is only issued upon the user (the deliveryman) granting consent to the collection of biometric data. When the RFID is detected (e.g., at a delivery location), a first verification can occur where the system verifies the owner of the RFID has provided consent to the collection of biometric data. The system can then turn on a camera, perform a biometric scan of the holder of the RFID who is purporting to the authorized user, verify the user as authentic, and turn off the camera. Data associated with the biometric scan can be deleted after the verification process concludes.

When the deliveryman accesses the distribution facility, a timestamp record of the entrance can be recorded. Likewise, when the deliveryman leaves the distribution facility, an additional timestamp record of the departure can be recorded. Preferably, when the deliveryman leaves, no second level confirmation (fob, voiceprint, etc.) is required, although in some configurations a secondary confirmation may be required. In some configurations, these records (the entrance/departure timestamp records) can be recorded in a database, such as a SQL database. In other configurations, the records can be recorded in blocks on a blockchain. The blockchain in such cases would be permissioned, meaning only facilities or systems with permission could add blocks to the blockchain. The blockchain could be publically accessible or privately accessible, based on needs of specific configurations, meaning in some configurations anyone can access the information recorded on the blockchain (public), whereas in other configurations only certain entities can access the data.

The disclosed systems and methods can be applied to any instance where ID needs to be presented. For example, the user verification system disclosed herein can be deployed for security checks (at locations such as airports, office buildings, concert venues), purchasing restricted materials (pharmaceuticals, paint products, fire arms), or presenting ID for legal activities (such as at a bank, notary public, etc.).

With respect to the facial recognition data used as input to the hash function, in one configuration this data is made of the relationships between features of the digital representation (such as the distance between the user's eyes, the distance from ear to ear, and the respective ratio of those distances). Because orientation of the head, distance from a camera, etc. can vary from instance to instance, the inputs to the hash function can be only relative/ratio values between the respective features of the face (e.g., the ratio of the distance between the eyes and the distance from ear to ear). The hash function then provides an output based on those relative values, which is compared to stored hash function outputs.

In another configuration, the relationships between facial features can be used to identify the face of the user, which has a corresponding face identification (face ID). The face ID can then be input into the hash function, and the resulting output can be compared to hash outputs stored in a database/ledger. Preferably, the system storing the hashed outputs of known users is kept separate from the facial recognition system which records the face and determines if the face matches a known identification.

In some configurations, the relationships between facial features, which are entered as inputs to the hash function, can be filtered, rounded, or otherwise adjusted before being input into the hash function. For example, if the user's previous biometric data included a measurement of “5” for a particular aspect, and on a given day, the sensor records “4.9,” the system can round the measurement to “5” before being input into the hash function. In this manner, a range of values, rather than a single value, can be used as the input to the hash function. The system can also, over multiple iterations, adjust the measurement if it finds the average has shifted over time. With this new, adjusted measurement, the threshold range for identifying the user will be based around the new adjusted measurement.

In some configurations, the biometric data of the facial recognition data and the second confirmation data can be further combined with geolocation data (such as GPS data). For example, in some instances there can be a geo-fence around a store. The system may have the user go to a specific known location within the store for store purchases, or may require that the user be within the geo-fence during any transaction associated with a user. In many instances, such requirements can operate in tandem with a fob, smartphone, or other RFID/GPS enabled device. For example, as a store associate approaches a restricted area, a facial recognition scanner may scan the store associate's face, recognize the face as that of an authorized user, then search for a fob's RF signal within a specific geolocation. If the fob is not located within the geolocation, access to the restricted area would be denied.

The challenge level, or the number of verification factors required, may increase with the dollar value of an item being purchased, or as the risk level of the area being accessed. For example, if another transaction was successfully completed within a pre-determined geographic location and/or within a pre-determined time period, the challenge level for a subsequent transaction could be reduced. Likewise, if a mobile device, fob, etc., is used for a transaction and remains within a geo-fence, subsequent challenge levels may be reduced.

While in many cases two confirmations may be required (hashed facial recognition output+2^{nd} confirmation data), in some circumstances additional confirmation data may be required. For example, hashed facial recognition output, fob data, and a voiceprint may be required. That is, systems configured according to this disclosure can have two or more required confirmations, where each respective confirmation after the facial recognition has a challenge level based on user history, schedules, security/importance of area being accessed, and/or value of item being acquired.

The disclosed system provides a technological improvement to existing security systems by using asymmetric cryptography in the form of hash algorithms applied to facial recognition data. This provides increased security to the data because the output of the hash function will appear to be randomized. Also, rather than needing to compare the many different relationships and aspects of the facial features to determine if the user is authorized, hash function outputs will vary if there is any change whatsoever. Therefore, the system can make a faster, more secure determination if the user's facial recognition data is associated with an authorized user than in previous systems. For example, in a large scale environment with many users and need for quick, secured verification, this makes the system more secure and efficient than previous systems. Moreover, the use of additional confirmation data, after the comparison of hashed facial recognition data, to perform an authorization provides a multi-factor authentication process which results in improved accuracy of identification systems.

The disclosure now turns to the specific examples illustrated in the figures. While specific examples are provided, elements of these examples may be removed, combined, or otherwise modified as required by a specific circumstance or configuration.

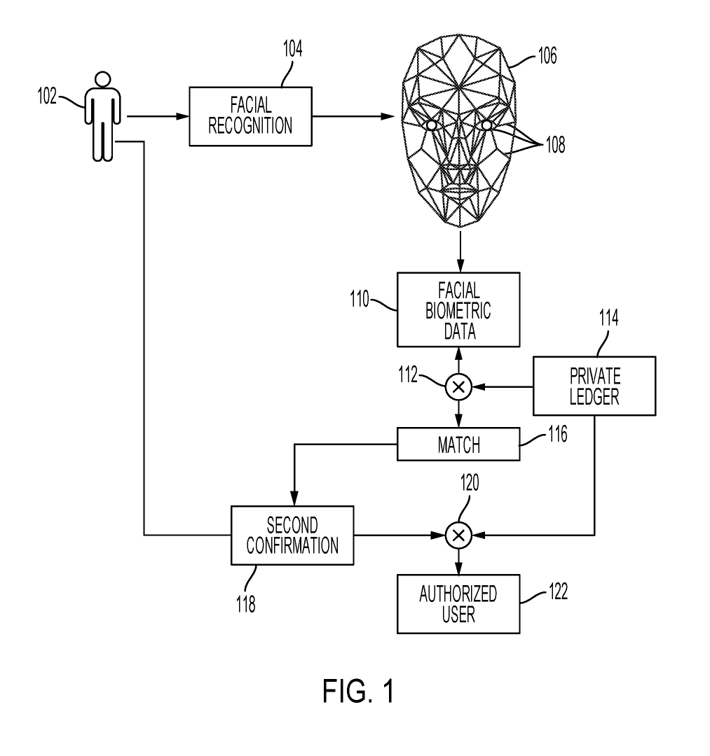

FIG. 1 illustrates an exemplary authentication of a user 102. As the user approaches a facial recognition scanner 104, the facial recognition scanner 104 captures optical data of the user's 102 face 106. The system (meaning the facial recognition scanner 104 or another computer receiving the optical data) then identifies relationships 108 between features of the user's 102 face 106, such as the distance between the eyes, eyebrows, mouth to chin, etc. This data, and in particular the ratios between the data, is facial biometric data 110, which is compared 112 to stored facial biometric data, stored in a private ledger 114. Preferably, the facial biometric data 110, or a facial ID associated with the facial biometric data 110, is used as the input to a hash function. The output of the hash function is then compared 112 to previously stored hash function output which is stored in the private ledger 114.

If there is a match 116, the system requests and/or receives a second confirmation 118. Exemplary second confirmations 118 can include RFID data from a fob, voiceprints, handprints, fingerprints, etc. This secondary confirmation data is also compared 120 to data from the private ledger 114. Preferably, the secondary confirmation data is also hashed, and the results are compared 120 to stored hash values in the private ledger 114. When multiple authentications have occurred and been successfully matched to stored values, the user 102 is authenticated 122.

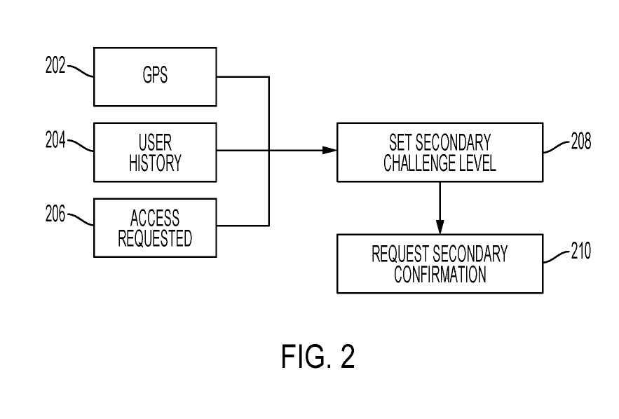

FIG. 2 illustrates a variable challenge level based on specific inputs. In this example, factors such as a GPS (Global Positioning System) device 202, a user history 204, and the access requested 206 are used to determine and set a secondary challenge level 208 after facial recognition data has been successfully compared. In one configuration, the various challenge types have predetermined difficulty values, and the inputs 202, 204, 206 are weighted, then summed together to determine which type of challenge should be issued 210. In another configuration, the access requested 206 can initially set the secondary challenge level 208, then the user history 204 can be used to mitigate or increase the challenge level. Upon setting the challenge level, the system can issue a request for secondary confirmation 210 to the user.

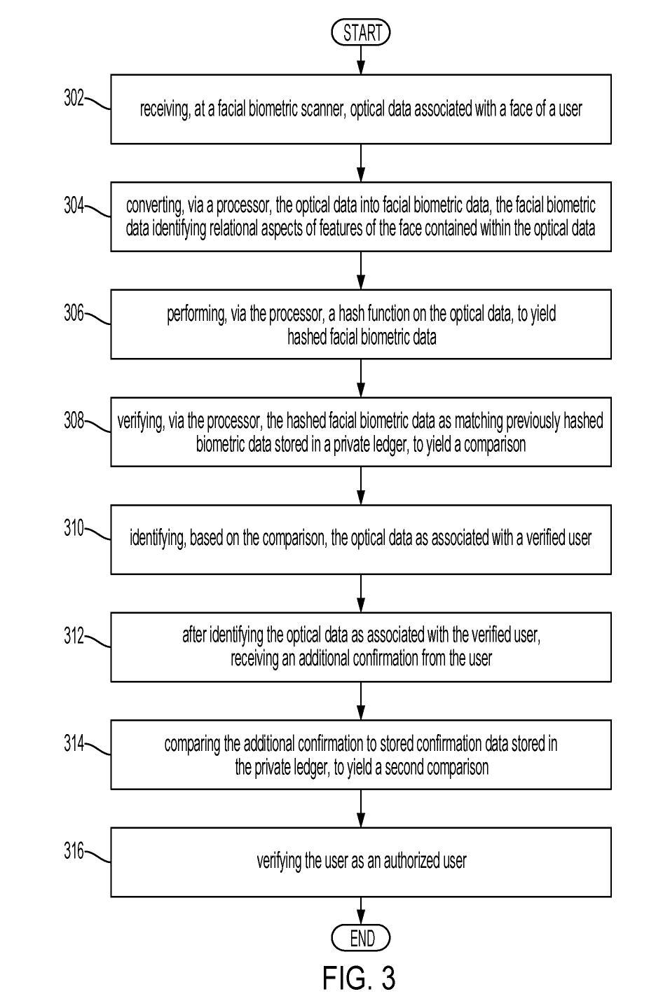

FIG. 3 illustrates an exemplary method embodiment. The steps outlined herein are exemplary and can be implemented in any combination thereof, including combinations that exclude, add, or modify certain steps. In this example, the system receives, at a facial biometric scanner, optical data associated with a face of a user (302). This optical data can be, for example, the light reflected off the face of the user. The system converts, via a processor, the optical data into facial biometric data, the facial biometric data identifying relational aspects of features of the face contained within the optical data (304). The processor can be specifically configured to perform facial recognition, and more particularly to identifying relational aspects of facial features.

The system performs, via the processor, a hash function on the optical data, to yield hashed facial biometric data (306) and verifies, via the processor, the hashed facial biometric data as matching previously hashed biometric data stored in a private ledger, to yield a comparison (308). The system identifies, based on the comparison, the optical data as associated with a verified user (310) and, after identifying the optical data as associated with the verified user, receives an additional confirmation from the user (312). The system compares the additional confirmation to stored confirmation data stored in the private ledger, to yield a second comparison (314), and verifies the user as an authorized user (316).

The illustrated method may be further expanded to include generating, upon verifying the user as the authorized user, a block comprising: an identity of the authorized user; and a time of verification; and transmitting the block to the private ledger.

Examples of the additional confirmation can include a voiceprint, a fob comprising a Radio Frequency transmitter, a mobile device having a GPS receiver, a handprint, a fingerprint, etc.

In some configurations, the optical data and the additional confirmation can be required for a transaction, or access to a restricted area. In such configurations, as the value of the transaction increases, or as a level of restriction increases, a level of security of the additional confirmation can also increase.

An exemplary hash function algorithm which may be used is the Secure Hash Algorithm with an output of 256 bits (SHA-256). In addition, the private ledger can be a blockchain ledger.

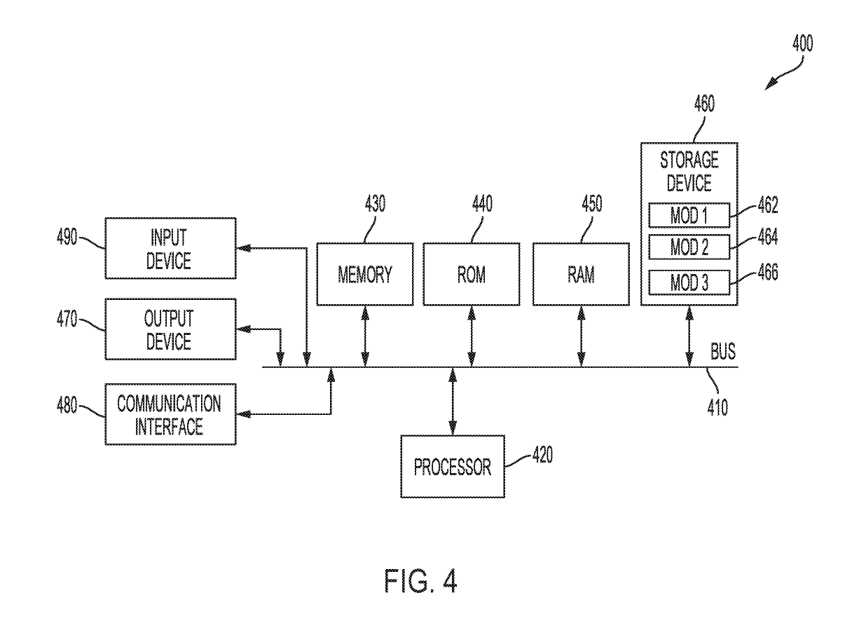

With reference to FIG. 4, an exemplary system includes a general-purpose computing device 400, including a processing unit (CPU or processor) 420 and a system bus 410 that couples various system components including the system memory 430 such as read-only memory (ROM) 440 and random access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
obtaining consent from a user to capture biometric data prior to any biometric data being captured;
verifying the consent of the user;
receiving, at a facial biometric scanner, optical data associated with a face of the user;
converting, via a processor, the optical data into facial biometric data, the facial biometric data identifying relational aspects of features of the face contained within the optical data;
performing, via the processor, a hash function on the optical data, to yield hashed facial biometric data;
verifying, via the processor, the hashed facial biometric data as matching previously hashed biometric data stored in a private ledger, to yield a comparison;
identifying, based on the comparison, the optical data as associated with a verified user;
after identifying the optical data as associated with the verified user, receiving an additional confirmation from the user;
comparing the additional confirmation to stored confirmation data stored in the private ledger, to yield a second comparison; and
verifying the user as an authorized user based on the second comparison.

2. The method of claim 1, further comprising:
generating, upon verifying the user as the authorized user, a block comprising:
an identity of the authorized user; and
a time of verification; and
transmitting the block to the private ledger.

3. The method of claim 1, wherein the additional confirmation is a voiceprint.

4. The method of claim 1, wherein the additional confirmation is a fob comprising a Radio Frequency transmitter.

5. The method of claim 1, wherein the optical data and the additional confirmation are required for a transaction.

6. The method of claim 5, wherein as a value of the transaction increases, a level of security of the additional confirmation also increases.

7. The method of claim 1, wherein the hash function is the Secure Hash Algorithm with an output of 256 bits (SHA-256).

8. The method of claim 1, wherein the private ledger is a blockchain ledger.

9. A system comprising:
a facial biometric scanner;
a processor; and
a computer-readable storage medium having instructions stored which, when executed by the processor, cause the processor to perform operations comprising:
receiving, at the facial biometric scanner, optical data associated with a face of a user;
converting the optical data into facial biometric data, the facial biometric data identifying relational aspects of features of the face contained within the optical data;
performing a hash function on the optical data, to yield hashed facial biometric data;
verifying the hashed facial biometric data as matching previously hashed biometric data stored in a blockchain ledger, to yield a comparison;
identifying, based on the comparison, the optical data as associated with a verified user;
after identifying the optical data as associated with the verified user, receiving an additional confirmation from the user;
comparing the additional confirmation to stored confirmation data stored in the blockchain ledger, to yield a second comparison; and
verifying the user as an authorized user based on the second comparison.

10. The system of claim 9, the computer-readable storage medium having additional instructions stored which, when executed by the processor, cause the processor to perform operations comprising:
generating, upon verifying the user as the authorized user, a block comprising:
an identity of the authorized user; and
a time of verification; and
transmitting the block to the blockchain ledger.

11. The system of claim 9, wherein the additional confirmation is a voiceprint.

12. The system of claim 9, wherein the additional confirmation is a fob comprising a Radio Frequency transmitter.

13. The system of claim 9, wherein the optical data and the additional confirmation are required for a transaction.

14. The system of claim 13, wherein as a value of the transaction increases, a level of security of the additional confirmation also increases.

15. The system of claim 9, wherein the hash function is the Secure Hash Algorithm with an output of 256 bits (SHA-256).

16. The system of claim 9, wherein the private ledger is a blockchain ledger.

17. A non-transitory computer-readable storage medium having instructions stored which, when executed by a computing device, cause the computing device to perform operations comprising:
receiving, at a facial biometric scanner, optical data associated with a face of a user;
converting the optical data into facial biometric data, the facial biometric data identifying relational aspects of features of the face contained within the optical data;
performing a hash function on the optical data, to yield hashed facial biometric data;
verifying the hashed facial biometric data as matching previously hashed biometric data stored in a blockchain ledger, to yield a comparison;
identifying, based on the comparison, the optical data as associated with a verified user;
after identifying the optical data as associated with the verified user, receiving an additional confirmation from the user;
comparing the additional confirmation to stored confirmation data stored in the blockchain ledger, to yield a second comparison; and
verifying the user as an authorized user based on the second comparison.

18. The non-transitory computer-readable storage medium of claim 17, having additional instructions stored which, when executed by the computing device, cause the computing device to perform operations comprising:
generating, upon verifying the user as the authorized user, a block comprising:
an identity of the authorized user; and
a time of verification; and
transmitting the block to the blockchain ledger.

19. The non-transitory computer-readable storage medium of claim 17, wherein the additional confirmation is a voiceprint.

20. The non-transitory computer-readable storage medium of claim 17, wherein the additional confirmation is a fob comprising a Radio Frequency transmitter.
